(19) United States
(12) Patent Application Publication
(10) Pub. No.: US 2008/0103807 A1
(43) Pub. Date: May 1, 2008

(54) Method and a system for rating party's electronic activities

(76) Inventor: Jean Dobey Ourega, Verdun (CA)

Correspondence Address: BROUILLETTE & PARTNERS, METCALFE TOWER, 1550 METCALFE STREET, SUITE 800, MONTREAL, QC, H3A-1X6, CA

(21) Appl. No.: 11/932,058

(22) Filed: Oct. 31, 2007

Related U.S. Application Data
(63) Continuation-in-part of application No. 11/816,491.

(51) Int. Cl. G06Q 99/00

(52) U.S. Cl. 705/1

(57) ABSTRACT

There is provided a method for rating party's electronic activities, the method comprising defining measurable parameters related to said party's electronic activities to be rated; collecting data corresponding to said defined measurable parameters; and generating an objective rating of said party's electronic activities using said collected data. There is also provided a rating unit for rating party's electronic activities, the rating unit comprising a objective rating module, where said module receives defined measurable parameters related to said party's electronic activities and collected data corresponding to said defined measurable parameters, processes said received defined measurable parameters and collected data, and generates an objective rating of said party's electronic activities as a result of said processing.

### CROSS-REFERENCES TO RELATED APPLICATIONS

This is a Continuation-In-Part of U.S. patent application Ser. No. 11/816,491 filed 16 Aug. 2007, which claims priority to the International PCT Application No. PCT/CA2006/000224 filed Feb. 16, 2006 and claims priority from U.S. Provisional Application No. 60/653,486 filed Feb. 17, 2005, the contents of which are hereby incorporated by reference in their entirety.

### FIELD OF THE INVENTION

The present invention relates generally to the field of commercial transactions, and more specifically to a method and a system for rating party's electronic activities.

### BACKGROUND OF THE INVENTION

Traditionally, rating systems used in electronic commerce are human-generated. In other words, it has been always a trading party who assigns a negative or a positive feedback to another trading party based on his personal satisfaction. Human generated rating is a subjective rating and can be easily subject to human manipulation.

### SUMMARY OF THE INVENTION

It is therefore an object of the present invention to provide methods and apparatus for objectively rating party's electronic activities without human interaction.

As a first aspect of the invention, there is provided a method for rating party's electronic activities, the method comprising:
defining measurable parameters related to the party's electronic activities to be rated;
collecting data corresponding to the defined measurable parameters; and
generating an objective rating of the party's electronic activities using the collected data.

The method preferably further comprises generating a rating profile of the party using the generated objective rating.

The collecting data preferably comprises monitoring over time the party's electronic activities, obtaining information related to the electronic activities based on the monitoring, and using the information and the defined measurable parameters to obtain the data corresponding to the defined measurable parameters.

Preferably, the method is essentially carried out by a mediator having a mediator server.

The collecting data and the generating an objective rating are preferably carried out by the mediator server using a computer program running thereon.

The defining measurable parameters can be carried out by the mediator.

The mediator server can be adapted to be connected to a network comprising the Internet. If it is the case, the defining measurable parameters can carried out by a third party over the network in order to rate the party's electronic activities.

The monitoring over time the party's electronic activities and the obtaining information related to the electronic activities can also be carried out over the network.

The party is preferably a trading party performing a commercial transaction over the network, the party's electronic activities are trading activities carried out by the trading party in connection with the commercial transaction, and the generating an objective rating comprises assigning a negative feedback for the trading party for carrying out an unsatisfactory action in accordance with the defined measurable parameters.

The trading party can be a buyer, and the measurable parameters can comprise at least one of a bid offer removal, an exchange offer removal, a failure to check out an item before deadline, a package declination, a failure to confirm a modified order before deadline, a failure to respond to a shipping request modification before deadline, a failure to select a carrier company before deadline, a failure to pay an order before deadline, a failure to pay shipping fees before deadline, a declination of an order before payment, a declination of a transaction on an item before check out.

The trading party can be a seller, and the measurable parameters comprise at least one of a failure to confirm an order before deadline, a failure to ship a purchased item before deadline, a failure to render an item during pickup scheduled time, and a declination of an order before confirmation.

The trading party can be a carrier, and the measurable parameters comprise at least one of a shipping request refusal, a failure to confirm a shipping request before deadline, a failure to pick up a package during scheduled time, and a failure to deliver a package on time.

As another aspect of the invention, there is provided a rating unit for rating party's electronic activities, the rating unit comprising an input/output unit and a processing unit, where the input/output unit receives collected data related to the party's electronic activities and transmits the collected data to the processing unit, where the processing unit processes the collected data as a function of defined rating criteria and generates an objective rating of the electronic activities as a function of the collected data and of the defined rating criteria.

The defined rating criteria can be predefined and stored in storage means accessible to the processing unit.

The rating unit preferably further comprises a profile generating module for generating a rating profile of the party using the generated objective rating.

As a further aspect of the invention, there is provided a rating system for rating party's electronic activities, the rating system comprising:
a collecting module for receiving defined measurable parameters related to the party's electronic activities to be rated, and for collecting data corresponding to the defined measurable parameters; and
a processing unit for receiving defined rating criteria and the collected data, for processing the collected data as a function of the rating criteria, and for generating an objective rating of the electronic activities as a function of the processing.

The rating system preferably further comprises a parameter defining module for defining the measurable parameters and transmitting the parameters to the collecting module.

The rating system preferably further comprises a rating criteria defining module for defining the rating criteria and transmitting the rating criteria to the processing unit.

The rating system preferably further comprises a profile generating module for generating a rating profile of the party using the generated objective rating.

The party's electronic activities are preferably carried out over a network, and the system is adapted to be connected to the network.

The rating system preferably further comprises a database and a monitoring module connected therebetween, where the monitoring module monitors over time the party's electronic activities over the network, collects the data related to the electronic activities as a result of the monitoring and stores the data on the database, where the collecting module collects the data corresponding to the defined parameters from the database.

The rating system preferably further comprises a parameter defining module for defining the measurable parameters and transmitting the parameters to the collecting module, where the collecting module comprises a processing module for processing the data on the database as a function of the parameters in order to collect the data corresponding to the defined parameters.

The parameter defining module preferably comprises a user interface and is adapted to be connected to the network for enabling a third party over the network to define the measurable parameters.

The system is preferably adapted to be connected to a system for concluding a commercial transaction over the network.

### DESCRIPTION OF THE DRAWINGS

These and other features of the invention will now be described with reference to the drawings of preferred embodiments, which are intended to illustrate and not to limit the invention, and in which:

FIG. 1 depicts a flowchart illustrating a first embodiment of a method for rating party's electronic activities according to the invention;

FIG. 2 depicts a flowchart illustrating a second embodiment of a method for rating party's electronic activities according to the invention;

FIG. 3 depicts a block chart illustrating a first embodiment of a rating unit according to the invention;

FIG. 4 depicts a block chart illustrating a first embodiment of a rating system connected to a system for concluding a commercial transaction over a network according to the invention;

FIG. 5 depicts a flowchart illustrating a first embodiment of a customer rating process as a part of a global system for concluding a commercial transaction, according to the present invention; and

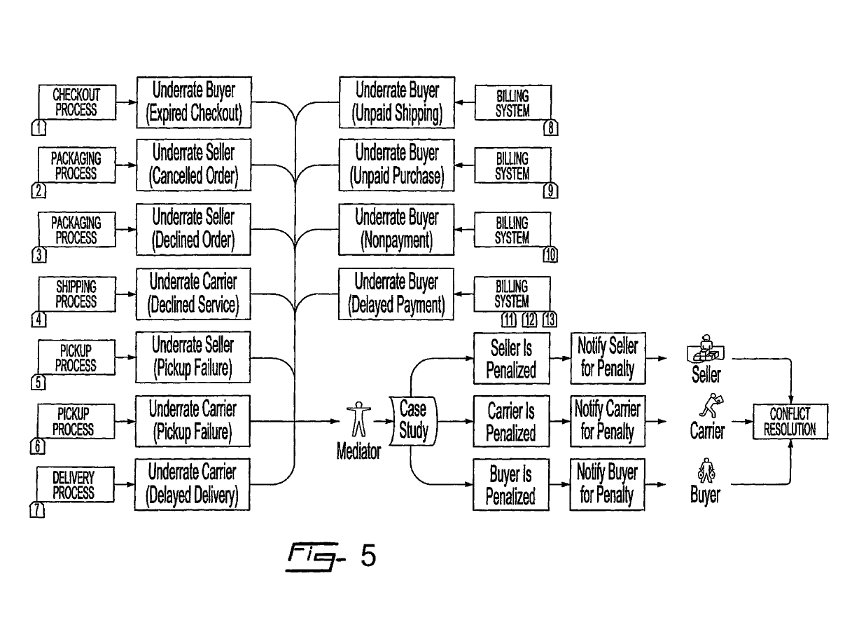

FIG. 6 depicts an example of a screen display of a potential record generated by the customer rating unit, as implemented in one embodiment of the present invention.

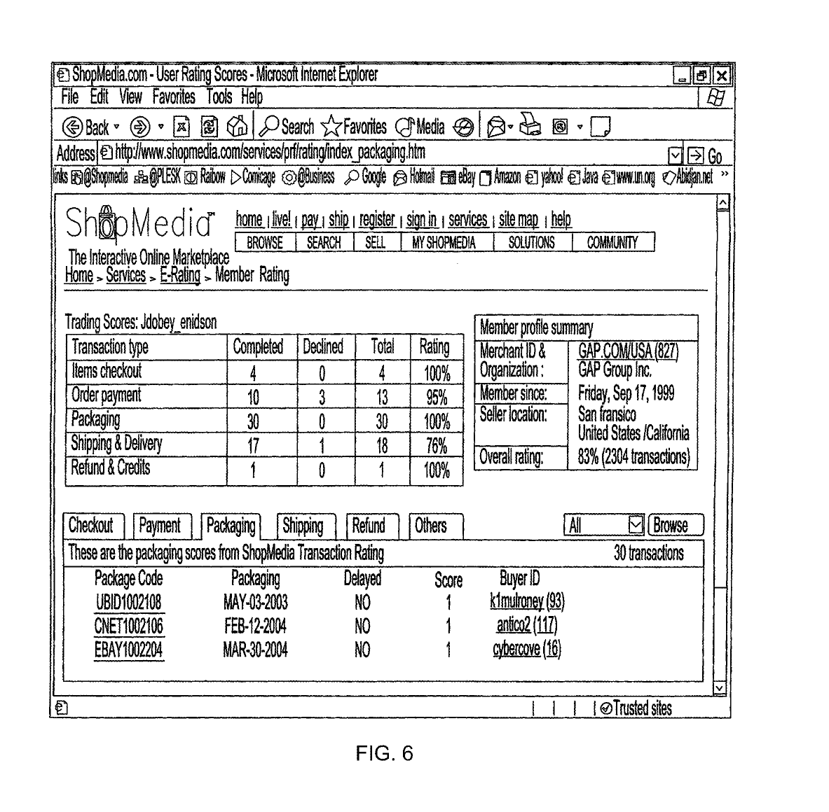

### DETAILED DESCRIPTION OF THE INVENTION

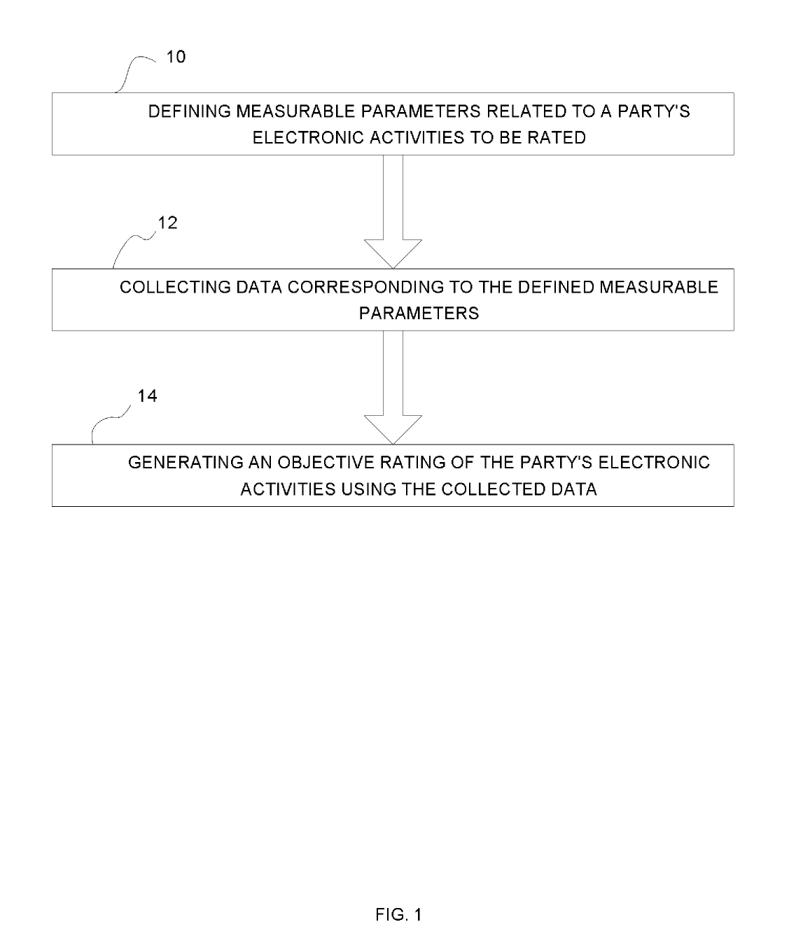

According to a first aspect of the invention, there is provided a first embodiment of a method for rating party's electronic activities according to the invention (see FIG. 1). Accordingly, the first step is to define measurable parameters related to party's electronic activities to be rated 10. The second step is to collect data corresponding to the defined measurable parameters 12, and the third step is to generate an objective rating of the party's electronic activities using the collected data 14.

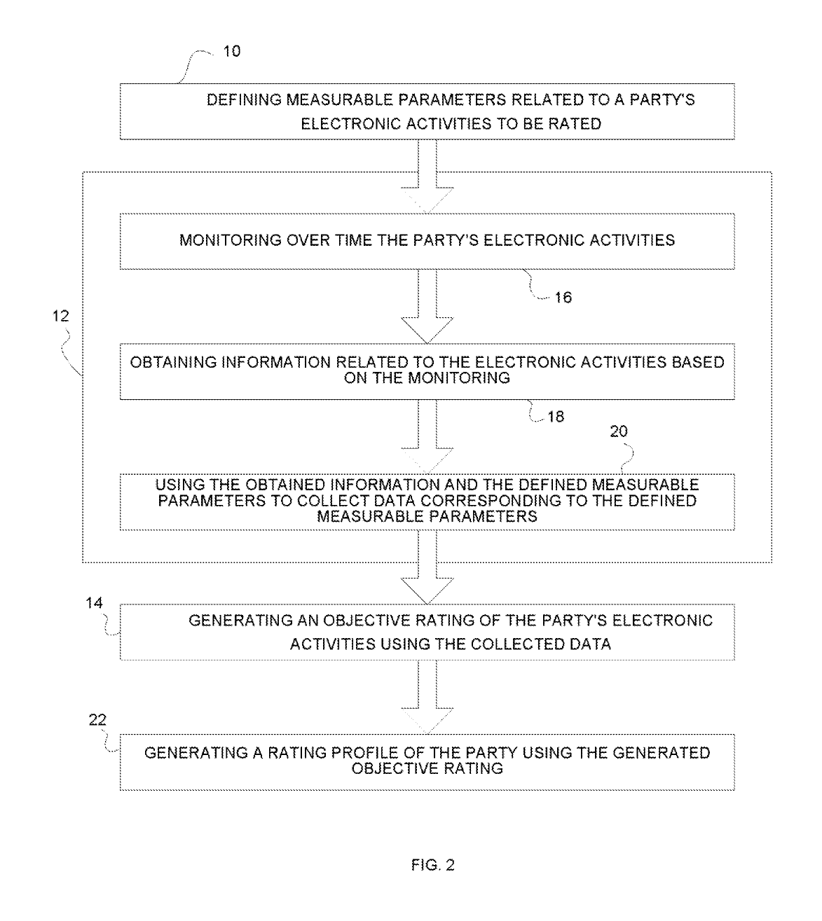

Referring to FIG. 2, and in accordance with one aspect of the method above-mentioned, the step of collecting data corresponding to the defined parameters 12 is carried out by monitoring over time party's electronic activities 16, obtaining information related to the monitored electronic activities 18, and using the obtained information to collect the data corresponding to the defined measurable parameters 20.

After collecting the data corresponding to the defined parameters, a rating profile of the party is generated using the generated objective rating 22.

In a preferred embodiment, the party to be rated is a trading party performing a commercial transaction over a network, the party's electronic activities are trading activities carried out by the trading party in connection with the commercial transaction. In this case, generating an objective rating comprises assigning a negative feedback for the trading party for carrying out an unsatisfactory action in accordance with the defined measurable parameters.

The trading party can be any user performing a commercial transaction over the network, among others, a buyer, a seller or a carrier.

As a first example, if the trading party is a buyer, the parameters to be measured related to the electronic activities to be rated could for instance comprise at least one of the following parameters: a bid offer removal, an exchange offer removal, a failure to check out an item before deadline, a package declination, a failure to confirm a modified order before deadline, a failure to respond to a shipping request modification before deadline, a failure to select a carrier company before deadline, a failure to pay an order before deadline, a failure to pay shipping fees before deadline, a declination of an order before payment, a declination of a transaction on an item before check out.

As a second example, if the trading party is a seller, the parameters to be measured related to the electronic activities to be rated could for instance comprise at least one of the following parameters: a failure to confirm an order before deadline, a failure to ship a purchased item before deadline, a failure to render an item during pickup scheduled time, and a declination of an order before confirmation.

As a third example, if the trading party is a carrier, the parameters to be measured related to the electronic activities to be rated could for instance comprise at least one of the following parameters: a shipping request refusal, a failure to confirm a shipping request before deadline, a failure to pick up a package during scheduled time, and a failure to deliver a package on time.

The methods, system and unit described here above are preferably carried out by a mediator having a mediator sever. If it is the case, then, the measurable parameters could be either predefined by a mediator or defined dynamically by a third party willing to get an objective rating of the party's electronic activities.

Once the measurable parameters defined, the second step is to collect data corresponding to the defined measurable parameters 12. The collecting is preferably carried out by the mediator using a computer program running on the mediator server. For instance, if the trading party to be rated is a buyer and the defined parameters are a bid offer removal and an exchange offer removal, the computer program running on the mediator server will collect data indicating if the buyer has removed in the past any bid or exchange offer. The data can be extracted from a database in which general data related to the party's electronic activities is stored. The general data stored is compiled and the extracted (or collected) data corresponds to the defined parameters.

Once the data corresponding to the defined measurable parameters is collected, the third step is to generate an objective rating of the party's electronic activities using the collected data 14. The objective rating is preferably carried out by the computer program running on the mediator server. It should be understood that an objective rating is a rating that is carried out without any human interaction.

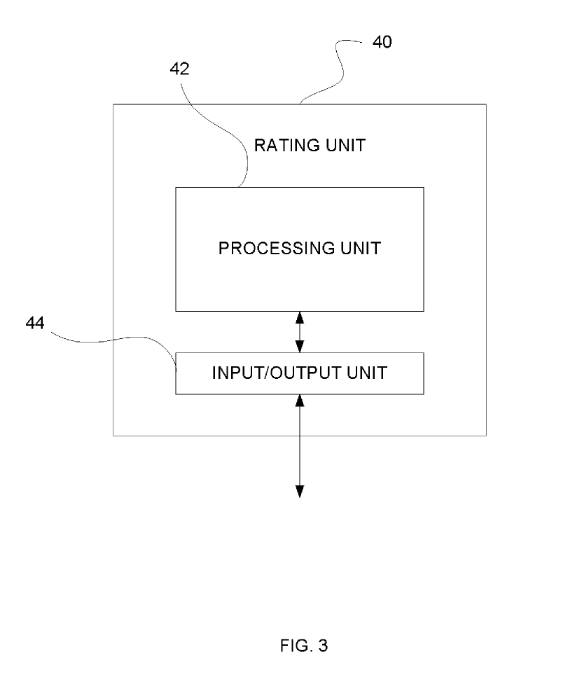

According to another embodiment of the invention, there is provided a rating unit 40 for rating party's electronic activities (see FIG. 3). The rating unit 40 preferably comprises an input/output unit 44 and a processing unit 42, where the input/output unit 44 receives collected data related to the party's electronic activities and transmits the collected data to the processing unit 42. The processing unit 42 processes the collected data as a function of defined rating criteria and generates an objective rating of the electronic activities as a function of the collected data and of the defined rating criteria.

The collected data received by the input/output unit is preferably data corresponding to the defined measurable parameters. The measurable parameters and the rating criteria can be communicated to the processing unit 42 either dynamically, via the input/output unit, or they can be predefined and stored in storage means, for example in a memory, accessible to the processing unit 42.

The rating unit preferably comprises a profile generating module for generating a rating profile of the party using the generated objective rating.

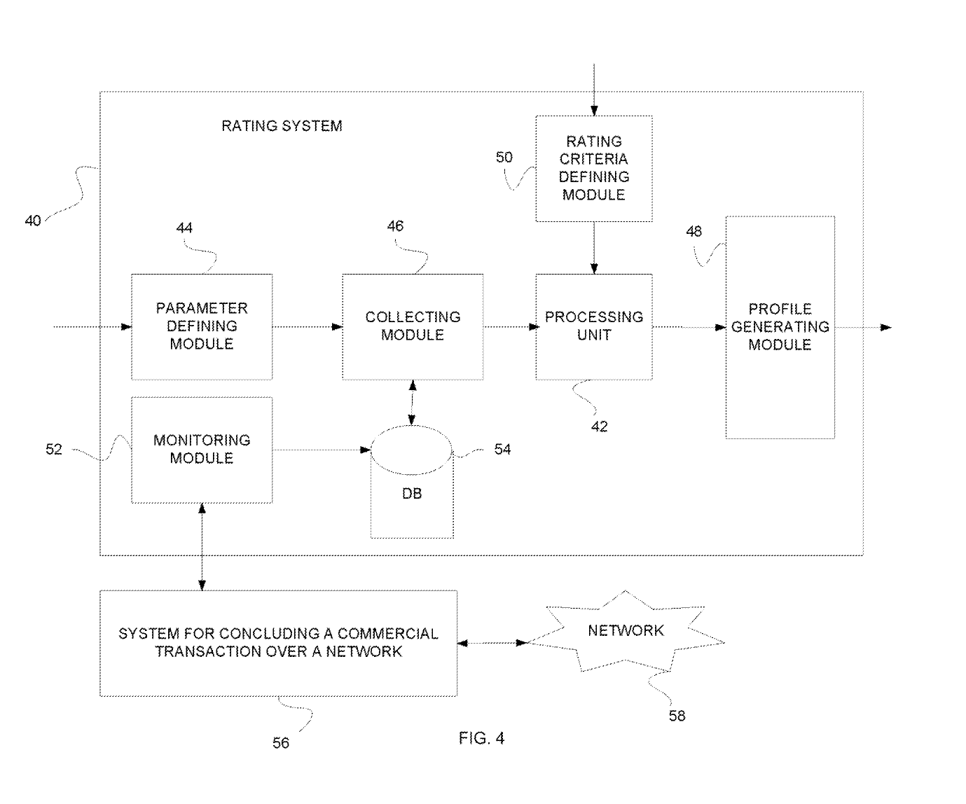

According to a further embodiment of the invention, there is provided a rating system for rating party's electronic activities (FIG. 4). The rating system 40 comprises a parameter defining module 44, a collecting module 46, a rating criteria defining module 50, a processing unit 42, a profile generating module 48, a monitoring module 52 and database 54.

The monitoring module 52 allows for monitoring over time the party's electronic activities, collecting information related to the electronic activities as a result of the monitoring and storing the collected data on a database 54 connected thereto. The parameter defining module 44 allows for defining measurable parameters and transmitting it to the collecting module 46 connected thereto. The collecting module receives the defined measurable parameters from the parameter defining module 44 and collects data corresponding to the defined parameters from the database 54 connected thereto. In order to collect the data corresponding to the defined parameters, the collecting module 46 preferably comprises a processing module for processing the data stored in the database 52 as a function of the defined parameters.

Once the data corresponding to the defined parameters is collected by the collecting module 46, the latter transmits the collected data to the processing unit 42 connected thereto. The processing unit 42 is also connected to the rating criteria defining module 50 that allows for defining rating criteria and transmitting it to the processing unit 42. The processing unit 42 receives the defined rating criteria and the collected data, processes the received data, and generates an objective rating of the party's electronic activities as a function of the processing.

The processing unit 42 transmits the generated rating to the profile generating module 48 connected thereto for generating a rating profile of the party.

The rating system can be used to rate trading party's electronic activities. In this case, the rating system is connected to a system for concluding a commercial transaction over a network 56, which system is usually connected to a network (ex. Internet) for allowing trading between various trading parties over the network.

As another embodiment of the invention, the rating system is integrated in a mediator's Web site. The rating system automatically monitors all transactions occurring on the site. This rating system, also referred to herein as ARTS (Automatically Rated Transaction System), aimed to ensure that each party actually delivers on what it has promised to other. The customer rating system is implemented by a computer program, referred to herein as the customer rating software that runs on the mediator's Web site. The customer rating system will now be described with reference to FIG. 3, which is a flowchart illustrating the customer rating process as a part of a global system for concluding a commercial transaction, as implemented in one embodiment of the present invention.

With reference to FIG. 3, the customer rating system is accessed via several modules, which include the checkout, packaging, shipping, pickup, delivery, and billing. When, triggered, the customer rating system will automatically generate a rating score for each user, e.g. seller, buyer, and carrier, based on the conclusion of the transactions they may be performing. For example, the customer rating system will underrate the buyer for any expired shopping cart (checkout process), and for a delayed payment or nonpayment (billing process).

On the other hand, the customer rating system will underrate the seller for any cancelled, declined or delayed order (packaging process), or as the negligent party after a pickup failure (pickup process). Finally, the customer rating system will underrate the carrier for any declined delivery request (shipping process), as the negligent party after a pickup failure (pickup process), or for any delayed delivery (delivery process). Any other rating criteria may be used to generate the user record.

For example, if a trading party conduct fraudulent activities, he will either be underrated or his account will be deactivated, dependant of the severity of the fraud of concern. In all cases, the customer rating system associates a score to each type of penalty. Hence, each time a trading party is penalized, the customer rating system will summarize his penalties. Then, the customer rating system will compute a rating score based on these penalties.

On benefit of such a rating system is that it automatically generate (e.g. without a human interaction) any feedback record, conversely to other rating systems used in electronic commerce that are human-generated. Hence, the automated transactions rating score, generated by the customer rating system, may be used by the mediator to help its online community, including visiting prospects, to accurately learn about other users' trading history on the mediator's Web site. The customer rating system may for example, provide impartial rating of any trading behavior of parties involved in transactions throughout the mediator's Web site.

In other words, this rating system will generate and create a rating record for each user in the customer database, based on any transaction interactions they have been performing on the mediator's Web site. More specifically, the customer rating unit evaluates the trading party's performance based on the conclusion specifics transactions, which will result to the creation of an entry record in the customer database.

Hence, this rating system will provide immediate help to any user visiting the mediator's Web site by providing then which a complete trading history about others. For example, the customer rating system will generate a record about the buyer payment habit (quick, late, nonpayment, etc.).

The customer rating system will also general a seller packaging record, which may include the number of completed/declined orders, the average score of goods availability.

The customer rating system will also create a carrier shipping/delivery record, which may include the number of services requests declined, and the total packages delivered/declined.

The customer rating system may also compute the total number of claims filed/received by a user. FIG. 4 illustrates an example of a screen display of a potential record generated by the customer rating unit, as implemented in one embodiment of the present invention. Although the rating criteria are extended, only overall rating record will be usually shown. However, a more informative details will be provided about any used by browsing the targeted customer rating record.

In a first embodiment, the above described rating system and unit can be implemented in firmware or software as a series of instructions which, when executed by a microprocessor or other computing device, perform the same function and produce the same result as a hardware embodiment described above. In other embodiments, one or more elements thereof could be implemented in hardware.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

1. A method for rating party's electronic activities, the method comprising:
defining measurable parameters related to said party's electronic activities to be rated;
collecting data corresponding to said defined measurable parameters; and
generating an objective rating of said party's electronic activities using said collected data.

2. The method as claimed in claim 1, further comprising generating a rating profile of said party using said generated objective rating.

3. The method as claimed in claim 1, wherein said collecting data comprises monitoring over time said party's electronic activities, obtaining information related to said electronic activities based on said monitoring, and using said information and said defined measurable parameters to obtain said data corresponding to said defined measurable parameters.

4. The method as claimed in claim 3, wherein said method is essentially carried out by a mediator having a mediator server.

5. The method as claimed in claim 4, wherein said collecting data and said generating an objective rating are carried out by said mediator server using a computer program running thereon.

6. The method as claimed in claim 5, wherein said mediator server is adapted to be connected to a network comprising the Internet.

7. The method as claimed in claim 6, wherein said defining measurable parameters is carried out by a third party over said network in order to rate said party's electronic activities.

8. The method as claimed in claim 6, wherein said monitoring over time said party's electronic activities and said obtaining information related to said electronic activities are carried out over said network.

9. The method as claimed in claim 8, wherein said party is a trading party performing a commercial transaction over said network, said party's electronic activities are trading activities carried out by said trading party in connection with said commercial transaction, and said generating an objective rating comprises assigning a negative feedback for said trading party for carrying out an unsatisfactory action in accordance with said defined measurable parameters.

10. The method as claimed in claim 9, wherein said trading party is a buyer, and said measurable parameters comprise at least one of a bid offer removal, an exchange offer removal, a failure to check out an item before deadline, a package declination, a failure to confirm a modified order before deadline, a failure to respond to a shipping request modification before deadline, a failure to select a carrier company before deadline, a failure to pay an order before deadline, a failure to pay shipping fees before deadline, a declination of an order before payment, a declination of a transaction on an item before check out.

11. The method as claimed in claim 9, wherein said trading party is a seller, and said measurable parameters comprise at least one of a failure to confirm an order before deadline, a failure to ship a purchased item before deadline, a failure to render an item during pickup scheduled time, and a declination of an order before confirmation.

12. The method as claimed in claim 9, wherein said trading party is a carrier, and said measurable parameters comprise at least one of a shipping request refusal, a failure to confirm a shipping request before deadline, a failure to pick up a package during scheduled time, and a failure to deliver a package on time.

13. A rating unit for rating party's electronic activities, the rating unit comprising an input/output unit and a processing unit, where said input/output unit receives collected data related to said party's electronic activities and transmits said collected data to said processing unit, where said processing unit processes said collected data as a function of defined rating criteria and generates an objective rating of said electronic activities as a function of said collected data and of said defined rating criteria.

14. A rating unit as claimed in claim 13, further comprising a profile generating module for generating a rating profile of said party using said generated objective rating.

15. A rating system for rating party's electronic activities, the rating system comprising:
a collecting module for receiving defined measurable parameters related to said party's electronic activities to be rated, and for collecting data corresponding to said defined measurable parameters; and
a processing unit for receiving defined rating criteria and said collected data, for processing said collected data as a function of said rating criteria, and for generating an objective rating of said electronic activities as a function of said processing.

16. The rating system as claimed in claim 15, further comprising a parameter defining module for defining said measurable parameters and transmitting said parameters to said collecting module and a rating criteria defining module for defining said rating criteria and transmitting said rating criteria to said processing unit.

17. The rating system as claimed in claim 16, further comprising a profile generating module for generating a rating profile of said party using said generated objective rating.

18. The rating system as claimed in claim 15, wherein said party's electronic activities are carried out over a network, and said system is adapted to be connected to said network.

19. The rating system as claimed in claim 18, further comprising a database and a monitoring module connected therebetween, where said monitoring module monitors over time said party's electronic activities over said network, collects said data related to said electronic activities as a result of said monitoring and stores said data on said database, where said collecting module collects said data corresponding to said defined parameters from said database.

20. The rating system as claimed in claim 19, further comprising a parameter defining module for defining said measurable parameters and transmitting said parameters to said collecting module, where said collecting module comprises a processing module for processing said data on said database as a function of said parameters in order to collect said data corresponding to said defined parameters.

21. The rating system as claimed in claim 20, wherein said parameter defining module comprises a user interface and is adapted to be connected to said network for enabling a third party over said network to define said measurable parameters.

22. The rating system as claimed in claim 18, wherein said rating system is adapted to be connected to a system for concluding a commercial transaction over said network, wherein said party is a trading party performing a commercial transaction over said network, and said party's electronic activities are trading activities carried out by said trading party in connection with said commercial transaction.

23. The rating system as claimed in claim 22, wherein said trading party is a buyer, and said measurable parameters comprise at least one of a bid offer removal, an exchange offer removal, a failure to check out an item before deadline, a package declination, a failure to confirm a modified order before deadline, a failure to respond to a shipping request modification before deadline, a failure to select a carrier company before deadline, a failure to pay an order before deadline, a failure to pay shipping fees before deadline, a declination of an order before payment, a declination of a transaction on an item before check out.

24. The rating system as claimed in claim 22, wherein said trading party is a seller, and said measurable parameters comprise at least one of a failure to confirm an order before deadline, a failure to ship a purchased item before deadline, a failure to render an item during pickup scheduled time, and a declination of an order before confirmation.

25. The rating system as claimed in claim 22, wherein said trading party is a carrier, and said measurable parameters comprise at least one of a shipping request refusal, a failure to confirm a shipping request before deadline, a failure to pick up a package during scheduled time, and a failure to deliver a package on time.
